(19) United States
(12) Patent Application Publication
(10) Pub. No.: US 2005/0287954 A1
(43) Pub. Date: Dec. 29, 2005

(54) System and method for monitoring a communications network

(76) Inventors: Chee Beng Lim, Singapore (SG); Loo Gerard, Singapore (SG); Dennis Sh Goh, Singapore (SG); Edwin Lim, Singapore (SG)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/878,815

(22) Filed: Jun. 28, 2004

(51) Int. Cl. H04Q 7/20

(52) U.S. Cl. 455/67.11; 455/67.13

(57) ABSTRACT

A system and method directed to testing various communication signals and related components in a communications network. In one embodiment of the invention, a first set of data about a signal is collected when the signal is at an origin point in the communications network. Further, a second set of data about the signal is collected when the signal is at a destination point in the communications network. These two snapshots of the signal in the system can then be analyzed to determine a quality measurement based on a comparison of the first set of data and the second set of data. With such a testing method and system, various signals throughout a communications network can be tested at analyzed at any point n the system and trouble spots or high traffic areas in the communications network can be identified more quickly.

### BACKGROUND OF THE INVENTION

Wireless technology and wireless communications systems have become quite prevalent in the world today. Mobile telephones and other mobile devices are able to communicate with mobile communications towers in more and more remote areas as wireless communication networks continue to grow and expand. With the advance of the size and breadth of wireless technologies, the need also increases for testing, maintenance, and troubleshooting of these wireless communication networks. As different wireless and communications technologies progress, upgrades to legacy communication networks and installation of newer components that interface with legacy networks has led to the increased need for regulation, standardization, and quality assurance throughout all communication networks.

Such technological advances have led to one such standard in mobile communication networks known as Third Generation Mobile System (“3G”). 3G networks provide for communications across a number of platforms and standardize mutually incompatible standards of the past such as GSM and CDMA. As such, Wireless Service Providers (WSPs) are gradually upgrading their mobile networks to 3G. In order to comply with the standards set forth by 3G, regulators of the mobile networks, in turn, must be able to test for and maintain standards on voice quality delivered by these upgraded systems. Even without regulation, voice quality issues remain a challenge as WSPs strive to increase the quality of their wireless network in the highly competitive arena of mobile communications as mobile-to-mobile communications comprises a large majority of the revenue generation for wireless communication companies.

Conventional signal analyzers, and the like, are common tools used in testing and troubleshooting mobile communications networks for actual signal transmission and degradation. However, these tools have not proven to be suitable for determining the elusive measurement of “voice quality” from one communications device to another as the human ear cannot, as of yet, interface directly with the communications network. Thus, voice quality testing is typically tested via air interfaces that measure sound waves. Further, any testing of the voice quality was typically accomplished separate from any testing of the signal quality.

In the past, one such system and method for obtaining a voice quality measurement utilized a “drive test” and system 100 as is shown in FIG. 1. The system in FIG. 1 includes a first mobile handset 120 that is able to communicate with a second mobile handset 125 over a wireless communications network via at least one wireless communication tower 115. Using a Voice Quality Testing Device 110 (VQT), an original test speech sample is fed to the mobile network via the first mobile handset 120 through the measurement interface of the VQT (source side). The first mobile handset 120 transmits the speech sample to the wireless communications network via at least the one communication tower 115, which, in turn, transmits the signal through the communications network via various communication hubs (not shown) where it is redirected back through the same path and the same communication tower 115 to the second mobile handset 125. The degraded speech sample is obtained through the measurement interface of the VQT 110 (destination side) that is interfaced with the second mobile handset 125. Then, a voice quality score (e.g. a Perpetual Evaluation of Speech Quality—PESQ) is then derived from the original and the degraded speech samples at the VQT 110.

The first 120 and second 125 mobile handsets are further coupled to a signal analyzer 150 in order to measure the quality of the actual signal that represents the speech sample when transmitted over the wireless communications network. Thus, the first mobile handset 120 is coupled to the signal analyzer 150 via a first data link 121 and the second mobile handset 125 is coupled to the signal analyzer via a second data link 126. Then, when the speech sample is initiated, the signal sent from the first mobile handset 120 can be compared to the signal received by the second mobile handset and an analysis of signal degradation can be performed at the signal analyzer.

However, this solution of the past has several limitations. First, the drive test is limited to a single test route. That is, the drive test itself will only test a single route between the first mobile handset 120 and the second mobile handset 125. Because each handset must be near both the VQT 110 and the signal analyzer 150, the test route is necessarily limited to the path through the closest wireless communications tower 115. Testing of other routes through other communications towers (not shown) requires moving to a new location. Only a single path through the closest wireless communication tower 115 can be tested during each test because the mobile handsets 120 and 125, cannot be in two different places (such that more than one path through other wireless communications tower is in the communications path) since they both are physically interfaced with the testing devices (the VQT 110 and the signal analyzer 150).

Second, the drive test is labor intensive and time-consuming. A technician must assemble the test station at each location desired to be tested. Then after the drive test system is configured and ready, the wireless call must be made from the first mobile handset to the second mobile handset 125. Then the test may be performed for the one wireless communications tower 115 through which the two mobile handsets 120 and 125 are communicating. If another wireless communications tower (not shown) and consequently, another signal route are to be tested, the technician must pack up the testing devices and travel to a new location and start all over again. Thus, in a large wireless communications networks having thousands of wireless communications towers, a technician (or several) would be required to perform thousands of drive tests.

Third, the drive test necessarily only tests a single path through the nearest wireless communications tower 115 during any given test. Further, the test for the signal quality and the test for the voice quality are performed independent of each other and any correlation of data collected must be done so outside of the scope of each respective data collection device. Thus, the conventional drive test cannot monitor both voice and signal quality on a network wide basis simultaneously.

Finally, the testing method and system is not capable of being used for real time analysis in response to user complaints. The time required for a technician to travel to a remote site, set up the necessary equipment, and perform the drive test does not lend itself to real-time troubleshooting and analysis. Thus, transitory or fleeting problems may not occur long enough to collect enough data for analysis by the time a technician is ready to do so.

As the mobile subscriber base grows, it has become imperative that the quality of voice calls meet subscriber's expectation. Poor call quality translates to customer dissatisfaction and lower average revenue per user (ARPU).

### SUMMARY OF THE INVENTION

An embodiment of the invention is directed to a system and method for testing various communication signals and related components in a communications network. In one embodiment of the invention, a first set of data about a signal is collected when the signal is at an origin point in the communications network. Further, a second set of data about the signal is collected when the signal is at a destination point in the communications network. These two snapshots of the signal in the system can then be analyzed to determine a quality measurement based on a comparison of the first set of data and the second set of data. With such a testing method and system, various signals throughout a communications network can be tested at analyzed at any point in the system and trouble spots or high traffic areas in the communications network can be identified more quickly.

According to anther embodiment of the invention, a system includes a plurality of distributed data acquisition interfaces operable to interface with a plurality of communication paths in a communication network and a computing environment coupled with each distributed data acquisition interface. The computing environment includes a communication system analysis program that contains several program modules. The program modules include a signal analysis module operable to receive transmissions from each of the plurality of distributed data acquisition interfaces, a call trace module operable to assimilate the received transmissions and to manipulate the data contained in the received transmissions, a signal quality measurement module operable to determine a signal quality based at least some of the data about the signals passing through various communication paths, and an integration module operable to interpret the signal quality measurement.

Having such a system operating concurrently, passively, and non-intrusively allows a technicians the ability to monitor, record, and analyze each and every signal passing through each and every communication path in a communication system. As such, problems, such as signal degradation, dropped call areas, communication hub malfunctions, and the like, can be easily identified. By eliminating the need for a technician to travel to physical locations for system testing, time and money is saved during troubleshooting, system maintenance, and system planning.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a conventional system for testing a communication network for signal quality and voice quality separately;

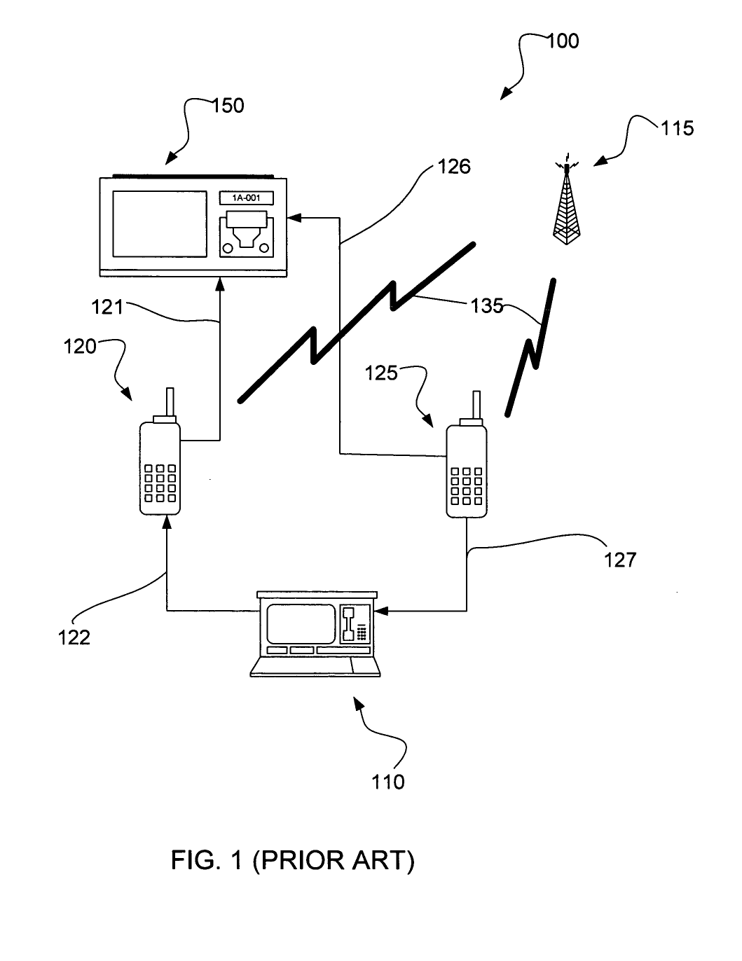

FIG. 2 shows an exemplary computing environment in which various embodiments of the invention may be practiced;

FIG. 3 shows a system for acquiring and analyzing signal data in a communication network according to an embodiment of the invention; and

FIG. 4 shows a network wide system for measuring signal quality in a communications system according to an embodiment of the invention.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

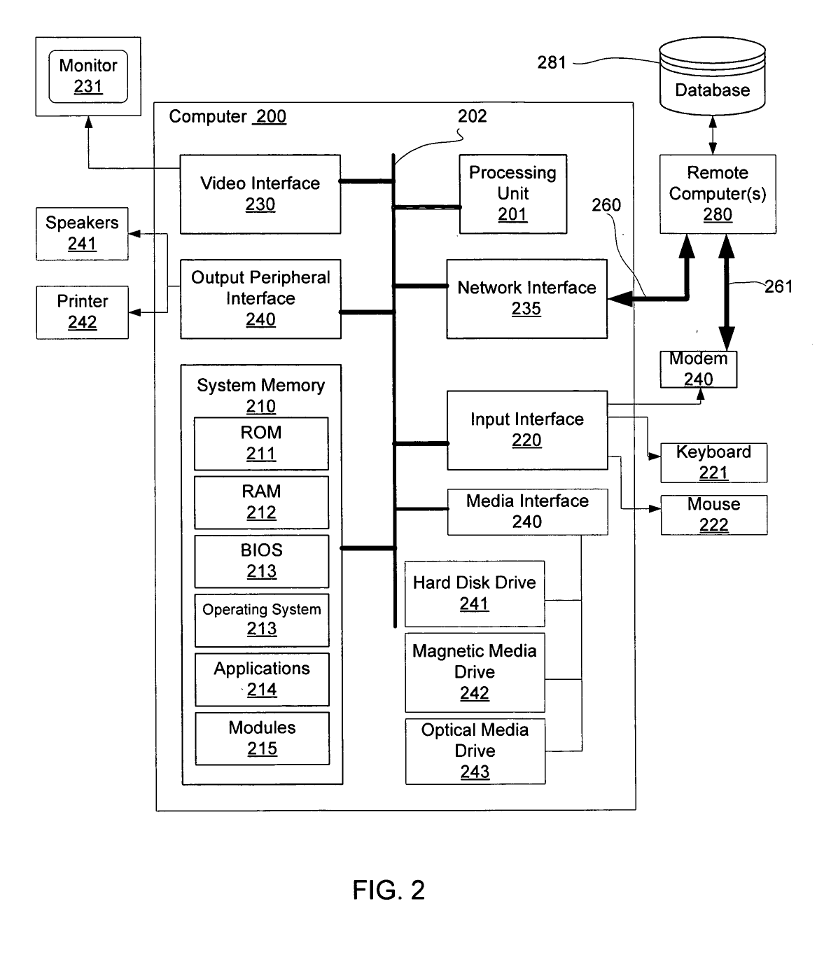

FIG. 2 and the following discussion are intended to provide a brief, general description of a suitable computing environment in which some embodiments of the invention may be implemented. Although not required, the invention will be described in the general context of computer-executable instructions, such as program modules, being executed by a personal computer. Generally, program modules include routines, programs, objects, components, data structures, etc. that collectively perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 2, an exemplary system for implementing the invention includes a general purpose computing device in the form of a conventional personal computer 200, including a processing unit 201, a system memory 210, and a system bus 202 that couples various system components including the system memory 210 to the processing unit 201. The system bus 202 may be any of several types of bus structures including a memory bus or memory controller, a peripheral bus, and a local bus using any of a variety of bus architectures. The system memory 210 includes read only memory (ROM) 211 and random access memory (RAM) 212. A basic input/output system (BIOS) 213, containing the basic routines that help to transfer information between elements within the personal computer 200, such as during start-up, is stored in the system memory 210. The system memory 210 may further include program applications 214 and program modules 215.

The personal computer 200 further includes a hard disk drive 241 for reading from and writing to a hard disk (not shown), a magnetic media drive 242 for reading from or writing to a removable magnetic disk (not shown), and an optical media drive 243 for reading from or writing to a removable optical disk (not shown) such as a CD ROM or other optical media. The hard disk drive 241, magnetic media drive 242, and optical media drive 243 are connected to the system bus 202 by one or more media interfaces 240 (only one shown). The drives and their associated computer-readable media provide both volatile and nonvolatile storage of computer readable instructions, data structures, program modules and other data for the personal computer 200.

Although the exemplary environment described herein employs a hard disk, a removable magnetic disk and a removable optical disk, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk, optical disk, ROM 211 or RAM 212, including an operating system, one or more application programs, other program modules, and program data, all of which are not shown). A user may enter commands and information into the personal computer 200 through input devices such as a keyboard 221 and pointing device 222. Other input devices (not shown) may include a microphone, joystick, game pad, satellite dish, scanner, or the like. These and other input devices are often connected to the processing unit 201 through an input interface 220 that is coupled to the system bus 202. The input interface 220 may be a serial port, a parallel port, a game port, a universal serial bus (USB) or any other interface. A monitor 231 or other type of display device is also connected to the system bus 202 via an interface, such as a video interface 230. One or more speakers 241 are also connected to the system bus 202 via an interface, such as an output peripheral interface 242. In addition to the monitor and speakers, a personal computer 200 typically includes other peripheral output devices, such as printer 242.

The personal computer 200 may operate in a networked environment using logical connections to one or more remote computers, such as remote computer 280. The remote computer 280 may be another personal computer, a server, a router, a network PC, a peer device or other common network node, and typically includes many or all of the elements described above relative to the personal computer 200, although only a memory storage device, such as a database 281 has been illustrated in FIG. 2. The logical connections depicted in FIG. 2 include a local area network (LAN) 260 and a wide area network (WAN) 261. Such networking environments are commonplace in offices, enterprise-wide computer networks, intranets and the Internet. As depicted in FIG. 2, the remote computer 280 communicates with the personal computer 200 via the local area network 260 via a network interface 235. The personal computer may also communicate with the remote computer 280 through the wide area network 261 which is via a modem 240 or other remote communications device.

When used in a LAN networking environment, the personal computer 200 is connected to the local network 261 through a network interface or adapter 235. When used in a WAN networking environment, the personal computer 200 typically includes a modem 240 or other means for establishing communications over the wide area network 261, such as the Internet. The modem 240, which may be internal or external, is connected to the system bus 202 via the input interface 220. In a networked environment, program modules depicted relative to the personal computer 200, or portions thereof, may be stored in the remote memory storage device. It will be appreciated that the network connections shown are exemplary and other means of establishing a communications link between the computers may be used.

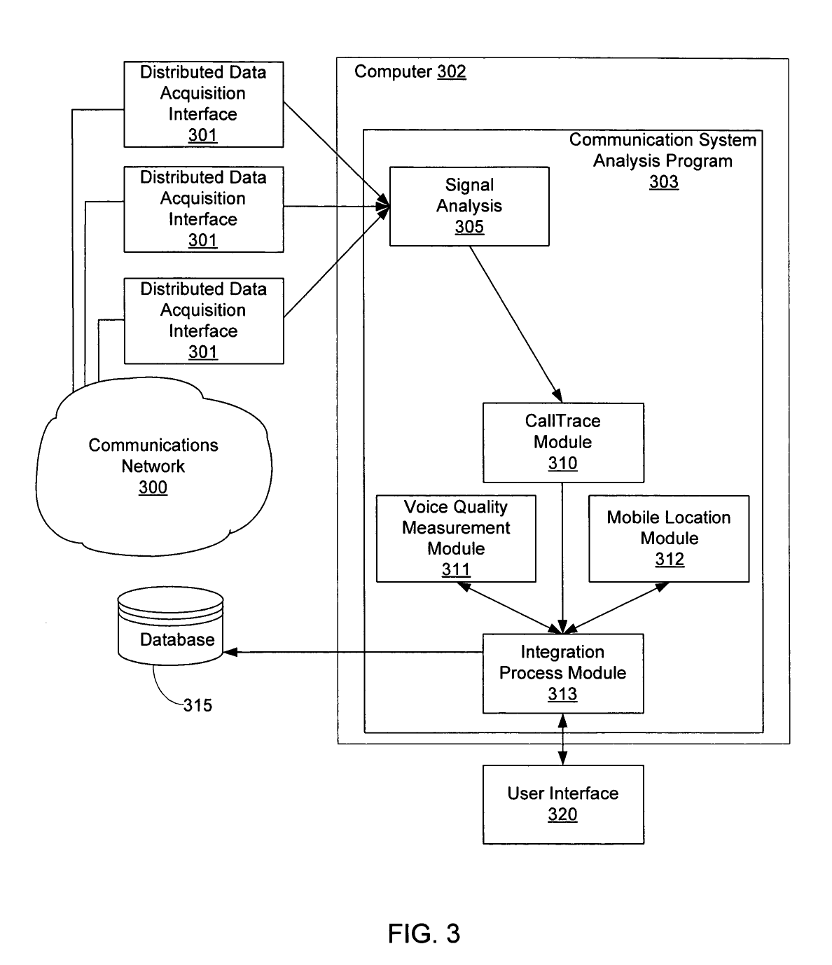

FIG. 3 shows a system for acquiring and analyzing signal data in a communication network 300 according to an embodiment of the invention. The system includes several subsystems that each work together to provide for data collection, analysis, storage, and manipulation for both voice and data signals in the communications network 300, which may be a wireless communications network. The subsystems include one or more distributed data acquisition interfaces 301, a communication system analysis program 303 for signal analysis and manipulation in a computer environment 200 and data display and storage in a user interface 320 and database 315 respectively. Each of these subsystems is described in greater detail below.

Signals in the communication network 300 propagate through many branches and paths. Data about these signals is needed for analysis of the signal and voice quality in each path. In order to collect data about system-wide communication signals, at least one interface point (but often many interface points) is chosen to be a data collection point. As such, data is acquired through one or more distributed data acquisition interfaces 301. In FIG. 3, three such distributed data acquisition interfaces 301 are shown, but a typical communications network 300 may include hundreds of different points where data may be collected and consequently hundreds of distributed data acquisition interfaces 301. For clarity, only three are shown in FIG. 3.

The distributed data acquisition interfaces 301 are non-intrusive devices that are operable to couple to various communication branches in the communications network 300. The various branches may be of any medium and bandwidth and examples of such communication branches include T1 connections (North American standard), E1 connections (European standard), Optical Carrier Level 3 (OC3), Ethernet, or any other communication standard and/or protocol suitable for transmitting communication signals. Further, most typical communication systems use some form of asynchronous transfer mode (ATM) for the various packets of data being transmitted. These bandwidth and protocol standards are well known in the industry and will not be discussed further herein.

The bandwidth and protocol in which the data is communicated is not relevant to the present invention, so long as underlying signals themselves may be monitored and recorded in a non-intrusive manner. That is, the signal itself is unaffected by the monitoring of the signal by the distributed data acquisition interfaces 301. Furthermore, each distributed data acquisition interface 301 may be configured to monitor and record any type of signal in the communication system branch, such as data signals, voice signals, etc. and subsequently collect data about the monitored signals.

Once data about the communications signals has been collected by the distributed data acquisition interfaces 301, the collected data is transmitted to a computing environment 302 having a communication system analysis program 303 running thereon for further processing and analysis. The communication system analysis program 303 resides in computing environment 302 in the embodiment of FIG. 3, which may be similar to the personal computer 200 described above with respect to FIG. 2. Other implementations are possible as well, such as remote manipulation via a server computer or a multi-platform computing environment, however, for brevity, this embodiment will only be described with respect to the computing environment 302.

The communication system analysis program 303 includes several program modules that are used to manipulate, compare, analyze, and store the collected data from the wireless communications network. The program modules typically reside in a memory of the computing environment 302 such as system memory 210 (FIG. 2) or in memory on hard disk drive 241 (FIG. 2). The program modules include a signal analysis module 305, a call trace module 310, a voice quality measurement module 311, a mobile location module 312, and an integration process module 313. Each of these modules is described in greater detail below.

When the data is first collected and transmitted to the computing environment 302, a signal analysis module 305 is used to receive, organize, and initially manipulate the data into a format for use by the other modules of the communication system analysis program 303. The signal analysis module 305 receives all collected data from each distributed data acquisition interface 301 coupled with the communications network 300 and reassembles the data for further processing. Any kind of signal, including voice signals and data signals, as represented by the collected data from each distributed data acquisition interfaces 301, may be assembled, decoded, and analyzed at the signal analysis module 305. As collected data is received and processed, it is then passed to the call trace module 310 to determine a number of different measurements of the signals in the communications system 300 in general. Data may be passed as soon as it is received to achieve a real-time analysis of signals in the communications system 300. Alternatively, the signal analysis module 305 may store all collected data for use at a later time during an offline or archived analysis of signals in the communications network 300.

Data collected at the signal analysis module 305 is typically organized according to information retrieved from the protocol. For example, in ATM, each ATM cell contains information about the signal path (virtual path identifier—VPI, virtual channel identifier—VCI, etc.) which is collectively referred to as the ATM header and the signal itself which is often called the payload. Using this information, the signal analysis module 305 is able to organize and manipulate the data collected in order to be presented to the call trace module 310 for in depth analysis of the signals themselves.

The call trace module 310 groups the data according to each call as identified by the header information. For example, in ATM, the ATM header information is used for identification. The call trace module 310 then organizes data according to the information contained in each respective grouping and sends respective portions of each grouping to other program modules for data calculations used in the overall analysis of signals. As such, the header data may be sent to the mobile location module 312 (described below) for extraction of locations and positions. At the same time, payload data (such as voice frames) may be sent to the voice quality measurement module 311 (also described below) to calculate a Mean Opinion Score (MOS) of the signal quality. Based on the values returned from the mobile location module 312 and voice quality measurement module 311, the call trace module 310 is able to track the time, positions, and voice quality of the particular call in which the data being analyzed corresponds.

The call trace module 310 may be further configured to issue a notification, such as a trouble ticket, when a call is detected to have voice quality deterioration based on set thresholds, e.g. duration of dip in MOS score and range of MOS. The call trace module 310 is also able to correlate information from the mobile location module 312 and voice quality measurement module 312 and the signaling information such that the location of one or both handsets involved in the particular call can be determined. That is, the geographical location of calls or cell in which calls originated and such that the call quality throughout the day can be determined.

As described briefly above, the voice quality measurement module 311 is able to perform non-intrusive or passive voice quality measurement. The payload for each ATM cell, which may be voice data, is extracted at the call trace module 310 and sent to the voice quality measurement module 311 to obtain an MOS. The voice quality measurement module 311 performs the calculations in a known manner to determine the MOS. In the past, examples of such MOS calculation include the Perceptual Evaluation of Speech Quality (PESQ), the Perceptual Speech Quality Measurement (PSQM) and the Perceptual Analysis Measurement Service (PAMS). Each of these calculation methods utilizes data that is not passive as is the case with the present invention. Since the data manipulation is passive, no reference input signal is required for obtaining the MOS; a typical MOS calculation used in conjunction with the present invention takes advantage of the passive data collected by the distributed data acquisition interfaces 301. As one skilled in the art may appreciate, this allows all calls to be monitored for their voice quality using similar MOS calculations.

Also described briefly above, the mobile location module 312 is able to calculate the position of mobile handsets based on the header information captured from the signal analysis module 305. If the communication system meets all 3G standards, such as a Universal Mobile Telecommunications System (UMTS), this module can also extract signaling capture, e.g. an Interface Position Calculation (IuPC). Because location information in communication system is one of the services required by the 3G network standard, the ability to determine position information is beneficial. Further, there are also mandatory requirements in Europe and the U.S. in the E112 and E911 regulations for a service provider to provide such information. However, for the purposes of the voice quality measurements, position information and calculation is not required. That is, the communication system analysis program 303 need not include the mobile location module 312 to calculate an MOS at the voice quality measurement module 311 and vice versa.

The last program module shown in FIG. 3 in the communication system analysis program 303 is the integration process module 313 which interprets, correlates, and presents all collected and calculated data in a readable format for use in either a user interface 320 or a database 315.

The user interface 320 (which may be the monitor 231 of FIG. 2) displays information according to a user's choice of formats. Such formats may include a display of errors and highlights any anomalies defined by user as a user may define the threshold level of the MOS score, etc. The user interface 320 also allows the user to monitor the MOS performance of signals that are system-wide, location-based, or subscriber-based.

The database 315 stores all data collected during the period of monitoring. The data may be stored on a temporary basis or may be archived for legacy analysis. Users can use the data from the database 315 for post-processing, optimizing or trouble-shooting purposes.

Between the user interface 320 and the collected data in the database 315, a user may easily review collected data for troubleshooting and real-time analysis. The integration process module 313 correlates all calculated MOS and position information into a readable and manageable format for a human user. The integration process module 313 contains several analysis routines that allow a user wide-ranging functionality is determining a number of aspects about all collected data. Some of these routines are described below.

According to one embodiment, the integration process module 313 may include an analysis routine for determining information about lost calls. A lost call is any call that has been dropped due to loss of communication signal. For example, during a wireless call, the caller may wander outside of a coverage area such that the signal to and from the nearest communications tower is degraded to the point of complete loss of connection. When this occurs, data collected about this call can be identified by the call trace module 310 and an analysis routine in the integration module 313 is able to determine a number of factors about the call such as location of each handset involved in the call, time of day, duration of call, voice quality of the call throughout its duration, etc. As such, a user of the computing environment 302 having the communications system analysis program 303 may be quickly informed about the details of a dropped call. Therefore, users are alerted to potential problems with the communications network 300 as the problems are occurring.

According to another embodiment, the integration process module 313 includes another analysis routine for determining the voice quality of all calls made during a specific period of time. Similarly, a determination may be made about the voice quality of all calls that originate from a single source or that culminate at a single source. Further yet, a determination can be made about the voice quality of all calls that follow a specific path or that include a particular communication hub in the path. In short, any number of voice quality measurements may be made about any number of parameters or combinations of parameters about calls. As such, a user may be able to quickly and easily tell that a specific location, communication hub, handset, etc., is causing degradations in the voice quality of calls.

According to another embodiment, the integration process module 313 may include another analysis routine for determining failures of specific components associated with the communication network 300. For example, a communication tower or communication hub may fail due to electrical storm damage. Because, data collected will reflect a problem in some portion of the communication network 300, a user of the communications system analysis program 303 may be quickly informed about the problem.

According to yet another embodiment, the integration process module 313 may include another analysis routine for a complete statistical analysis of the communication network 300 in general. All call information including all voice quality measurements and corresponding location information may be assimilated to develop a network-wide analysis of all calls during a time period such as one day. The statistical analysis may show trends and patterns that identify weak areas in the communication network 300 such that engineers may be alerted to potential problems and network administrators may adequately and effectively plan for additional equipment and system improvements.

Other analysis routines, such as caller pattern analysis and network traffic analysis, may utilize the collected data but are not described further herein for brevity.

The communications system analysis program 303 described with respect to FIG. 3 has several advantages over conventional systems. First, the communications system analysis program 303 provides full network monitoring of voice quality in real-time for every call while the call is connected. This capability may be provided 24 hours a day and seven days a week from a single location, such as the network administration control room. As such, a technician does not need to travel to any remote location to perform tests to determine any number of factors about the communication network 300.

Second, the communications system analysis program 303 is able to identify and isolate geographical regions with poor voice quality based on the collected data. This analysis can be performed prior to or during the installation of new towers in new geographic areas. Thus, problem areas can be identified before communication towers are constructed, not to mention long before customers call to complain about the problem areas.

Third, the communications system analysis program 303 is able to profile the call quality of typical calls. For example, the communications system analysis program 303 may be used to determine the average quality of calls over the last 10 seconds, for all calls lasting longer than 30 seconds, etc. Combined with handset IDs, this feature can be further used in signals to isolate base stations with technical failures. Further, this allows service providers the ability to determine the particular location (i.e., where the particular distributed data acquisition interface 303 is located) at which a call's quality deteriorates. Other advantages are apparent but will not be highlighted further for brevity.

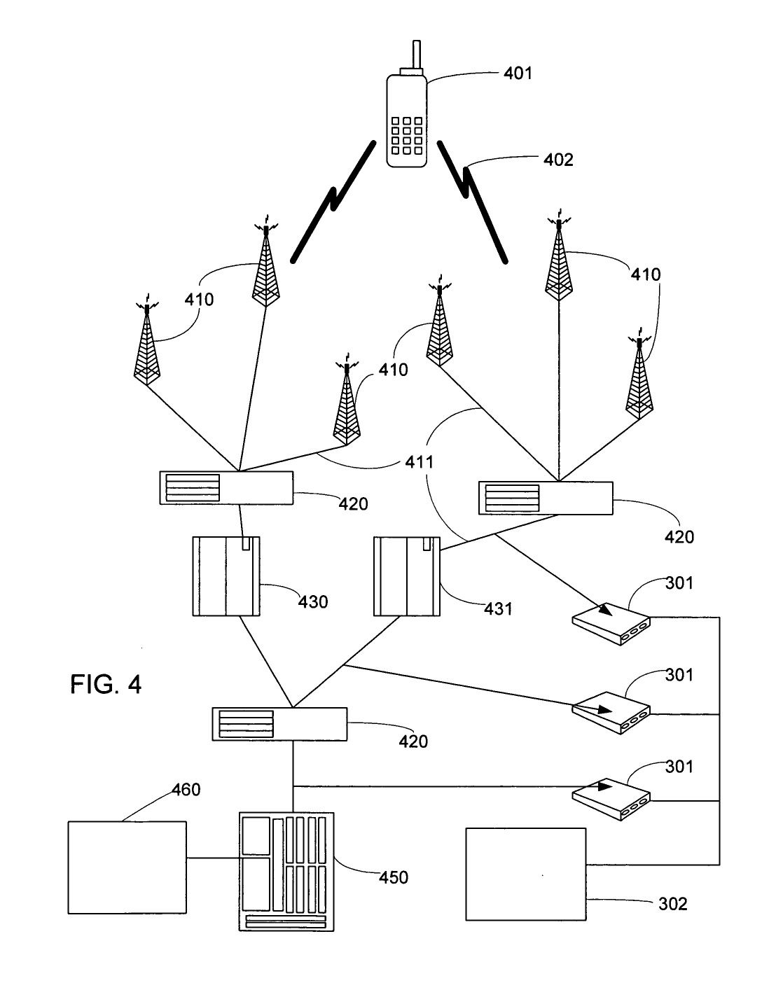

FIG. 4 shows a network wide system 400 for measuring signal quality in a communications system according to an embodiment of the invention. The system 400 of FIG. 4 shows a representative number of communications towers 410, ATM multiplexors 420, and other communications modules arranged in various communication branch structures. Of course, the representation in FIG. 4 is for illustrative purposes and is not intended as a limitation on any system that may utilize the various embodiments o the invention.

FIG. 4 shows a single mobile handset 401 that is operable to communicate via wireless transmissions 402 with any number of communication towers 410 in a communication network. In some technologies, such as the Code Division Multiple Access (CDMA) technology, the mobile handset may be operable to communicate with more than one communication tower 410 simultaneously. In any case, all wireless signals transmitted and received from the communications towers 410 are also passed through an ATM multiplexors 420 in order to maximize the use of limited bandwidth in the land lines 411 connected to each communication towers 410. The land lines may be of any standard as mentioned previously, such as E1, T1, OC3, Ethernet, etc. Furthermore, the land lines 411 are merely named as such for the purposes of this illustration and may be other technologies such as microwave or satellite transmissions.

Signals transmitted through ATM multiplexors 420 connected to communications towers 410 are, in turn, connected to communication hubs, such as a base station controller 430 or a radio network contoller 431. Again, other communication hubs are possible but are not illustrated here for brevity. Several communication hubs may also be connected to another ATM multiplexor 420 in order to further take more advantage of limited bandwidth. As such, all signals in a given system eventually route through a switching center, such as mobile switching center 450. The mobile switching center 450 may, in turn, be connected to a Public Switch Telephone Network 460 (PSTN). In this manner, signals received from a first mobile handset 401 may be received by the nearest communication tower 410, transmitted through various ATM multiplexors 420 and communication hubs 430 to the mobile switching center 450 where the signal is redirected to a destination point (which may be a second mobile handset—not shown) in a similar but opposite path. Alternatively, the signal may be routed out to another communication network through the PSTN 460.

With such a system, a great number of mobile handsets, land-line telephones, and other communication devices may communicate with each other such that thousands upon thousands of signals are being transmitted back and forth throughout every path of the communication network 400. As was described above, it is beneficial to be able to monitor and record these signals in a non-intrusive manner at each branch in the communication network 400. Thus, several distributed data acquisition interfaces 301 are coupled with the various branches of the communication network 400. Only three are shown in FIG. 4 for ease of illustration, but a typical system may include a distributed data acquisition interface 301 on every single branch in order to collect all data about every signal. Then, as was the case in FIG. 3, each distributed data acquisition interface 301 is coupled to a computing environment 302 in order to receive, assimilate, analyze and store all data collected.

As was described above with respect to FIG. 3, the collected data can be analyzed to locate and identify system problems. For example, the data may show that all signals degrade after passing through radio network controller 431 indicating that perhaps this communication hub is problematic. As another example, all signals received at a specific communication tower 410 may be weak indicating that the communication tower 410 is poorly located with respect to the users that are closest to it. As a final example, a technician may be able to capture specific data about a specific call over the previous ten seconds in order to troubleshoot the call in real time and quickly identify why signal degradation exists. This is particularly advantageous when an angry customer is demanding to immediately know why voice quality is so poor on calls recently (or even currently being) made. There are many other examples of using the data collected to troubleshoot, analyze, organize, and plan a communication network 400, but again, each and every use will not be covered in detail for brevity.

1. In a communication network, a method, comprising:
collecting data about signals in the communication network, the data collected at a plurality of interface points in the communication network;
storing the collected data in a memory in a computing environment; and
performing an analysis of the data using a communication system analysis program running in the computing environment to determine the quality of signals corresponding to the collected data.

2. The method of claim 1 wherein the determining the quality of the signals further comprises determining the quality of a voice component of the signals.

3. The method of claim 1, further comprising determining the physical location of at least one mobile handset corresponding to at least one signal in the communication network.

4. The method of claim 1, further comprising identifying an area of communication network that corresponds with degraded signals as determined by the quality the signals in the area of the communications network.

5. The method of claim 10, further comprising identifying a time of day in which signals are degraded in the communications system based on a comparison of at least two days of collected data about the signals in the communication system.

6. The method of claim 1, further comprising identifying a communication hub in the communication network that is causing degradation in signals that pass through the communication hub based on the collected data about signals in the communication network.

7. A communication system, comprising:
a plurality of distributed data acquisition interfaces operable to interface with a plurality of communication paths in a communication network such that signals passing through the plurality of communication paths are monitored; and
a computing environment coupled with each distributed data acquisition interface, the computing environment having a program running thereon, the program including:
a signal analysis module operable to receive transmissions from each of the plurality of distributed data acquisition interfaces, the transmissions comprise data about the respective monitored signals in the communication path to which each distributed data acquisition interface corresponds;
a call trace module operable to assimilate the received transmissions and to manipulate the data contained in the received transmissions;
a signal quality measurement module operable to determine a signal quality based at least some of the data about the signals passing through the plurality of communication paths; and
an integration module operable to interpret the signal quality measurement.

8. The system of claim 7 wherein the program further comprises a mobile location module operable to determine the location of at least one mobile handset corresponding to at least one signal passing through the plurality of communication paths.

9. The system of claim 7, further comprising a user interface coupled with the computing environment and operable to present the interpretations of the integration module.

10. The system of claim 7, further comprising a database operable to store the data collected about the signals passing through the plurality of communication paths.

11. A computer-readable medium having computer-executable instructions wherein the computer-executable instructions are operable to:
receive data about a plurality of signals passing through the plurality of communication paths in a communication network;
format the received data into a format suitable for use in a call trace module;
assimilate the formatted data into groups organized by the data's correspondence to a particular call in which each signal is associated;
determine the quality of at least one signal based on a comparison of the data about the signal to the data about another signal, wherein each of the two signals correspond to the same call; and
integrating the determined quality into a format suitable to presented to a user.

12. The computer-readable medium of claim 11 wherein the computer-executable instructions are further operable to determine to determine the location of at least one mobile handset corresponding to at least one signal passing through the plurality of communication paths.

13. The computer-readable medium of claim 11 wherein the computer-executable instructions are further operable to determine the quality of a voice component of the signals.

14. The computer-readable medium of claim 11 wherein the computer-executable instructions are further operable to identify an area of communication network that corresponds with degraded signals as determined by the quality of the signals in the area of the communications network.

15. The computer-readable medium of claim 11 wherein the computer-executable instructions are further operable to identify a time of day in which signals are degraded in the communications system based on a comparison of at least two days of collected data about the signals in the communication system.

16. The computer-readable medium of claim 11 wherein the computer-executable instructions are further operable to identify a communication hub in the communication network that is causing degradation in signals that pass through the communication hub based on the collected data about signals in the communication network.

17. In a communications network, a method comprising:
collecting a first set of data about a signal when the signal is at an origin point in the communications network;
collecting a second set of data about the signal when the signal is at a destination point in the communications network; and
determining a quality measurement based on a comparison of the first set of data and the second set of data.

18. The method of claim 17 wherein the signal comprises a voice signal.

19. The method of claim 17 wherein the signal comprises a data signal.

20. The method of claim 17, further comprising propagating the signal through a first path that includes a first communications tower nearest to the origin point and a second path that includes a second communication tower nearest to the destination point.

21. The method of claim 17 further comprising:
collecting a third set of data about a second signal when the second signal is at a second origin point in the communications network;
collecting a fourth set of data about the second signal when the second signal is at a second destination point in the communications network; and
determining a quality measurement based on a comparison of the third set of data and the fourth set of data.

22. The method of claim 21 wherein the first and second sets of data comprise data about a voice signal and the third and fourth sets of data comprise data about a data signal.

23. The method of claim 17, further comprising:
collecting a third set of data about the signal when the signal is at a point in the communications network that is different from the origin point and the destination point; and
determining a quality measurement based on a comparison of the first, second and third sets of data.

24. The method of claim 17, further comprising storing the quality measurement in a data storage.

25. The method of claim 17, wherein the communication network comprises a wireless communication network.
